(19) United States
(12) Patent Application Publication
(10) Pub. No.: US 2007/0054110 A1
(43) Pub. Date: Mar. 8, 2007

(54) Light-reflecting polycarbonate resin sheet and light-reflecting laminate using same

(75) Inventors: Hiroshi Kawato, Chiba (JP); Masami Kogure, Chiba (JP); Keisuke Funaki, Chiba (JP); Yosihiko Horio, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Idemiksu Kosan Co. Ltd, Tokyo (JP)

(21) Appl. No.: 10/574,580

(22) PCT Filed: Oct. 5, 2004
(86) PCT No.: PCT/JP04/14650

§ 371 Date: Apr. 4, 2006

(30) Foreign Application Priority Data
Oct. 8, 2003 (JP) 2003-349415

(51) Int. Cl. B32B 9/00; B32B 3/26

(52) U.S. Cl. 428/318.4; 428/304.4

(57) ABSTRACT

A light-reflecting polycarbonate resin sheet is characterized in that a light-resistant layer for cutting or absorbing ultraviolet light is provided on at least one side of a polycarbonate resin foam layer. A light-reflecting laminate is obtained by superposing such a light-reflecting polycarbonate resin sheet on a metal plate. The light-reflecting polycarbonate resin sheet has high light resistance while maintaining excellent reflective characteristics.

### FIELD OF THE INVENTION

The present invention relates to a light-reflecting polycarbonate resin sheet and a light-reflecting laminate using thereof. More specifically, the present invention relates to a light-reflecting polycarbonate resin sheet and a light-reflecting laminate using thereof, which are suitably used for light-reflecting panels for back light units of liquid crystal displays, lighting fixtures, fluorescent lamps for housing and various facilities, or light source parts such as LED (light-emitting diodes), EL (electroluminescence elements), plasma, laser, and the like.

### BACKGROUND ART

In general, a light-reflecting foamed sheet (hereinafter, film is also in the category of sheet) includes a metal plate or foil/foamed plastics sheet, a metal deposited foamed plastics sheet, a foamed stretched PET film or its metal laminate, and the like.

In recent years, the light-reflecting foamed sheet has widespread in use for liquid crystal displays and is expected to make still larger growth, especially in use for liquid crystal TVs as well as in the usual use for notebook computer displays. In the use for liquid crystal TVs, a direct backlight is used as a light source so as to obtain high-brightness and high-definition in a medium-size screen or a wide-screen of 508 mm (20 inches) or more. Various kinds of materials are proposed for the light-reflecting panel thereof.

For the light-reflecting panel of the direct backlight for liquid crystal displays, a laminate made of a foamed PET film or a micro-cellular foamed PET film and an Al plate is used, however, from the viewpoint of weight reduction and designing, there is a need for a light-reflecting panel made of plastics.

Among other materials, a micro-cellular foamed PET film is known as a foam sheet with a high light-reflecting property (Referenced Patent Document 1).

Further, a light-reflecting panel using a foam which is, a light-reflecting panel made of a foam (polycarbonate-polydimethylsiloxane copolymer) using polycarbonate resin (PC resin) as a foam prepared by finely foaming a resin composition is known (Referenced Patent Document 2).

In the direct backlight for liquid crystal displays, the light-reflecting panel is placed in close vicinity to a plural of light sources (cold-cathode tubes), so that the light-reflecting panel is required to have resistance to the wavelength specific for the light sources.

In addition, along with a recent development of wide-screen liquid crystal displays, still higher brightness is requested. In the direct back light for liquid crystal displays, a light-reflecting panel made of conventional foamed PET films or micro-cellular foamed PET films does not provide sufficiently high light-reflecting property requested.

A light-reflecting panel made of a foam of polycarbonate resin has a higher light reflectance, but it does not possess sufficient light resistance as compared with the light-reflecting panel using the micro-cellular foamed PET films.

Referenced Patent Document 1: Japanese patent publication No. 2925745.

Referenced Patent Document 2: Japanese published examined application No. 2003-49018.

### DISCLOSURE OF THE INVENTION

The present invention was made in view of the above-described situation of problems. It is therefore an object of the present invention to provide a foamed sheet for a light-resistant, light-reflecting article having excellent light-reflecting properties and a laminate using thereof.

The present inventors have intensively investigated to solve the above-described problems, and as a result, have found that a foamed sheet for a light-resistant, light-reflecting article having excellent light-reflecting properties can be obtained by incorporating a light-resisting layer which cuts or absorbs UV light into a foam layer of polycarbonate resin, particularly into a foam layer comprising a resin composition containing a copolymer of polycarbonate and polysiloxane. The present invention has been accomplished based on this finding.

Accordingly, the present invention provides a light-reflecting polycarbonate resin sheet and a light-reflecting laminate using thereof, which are described below:

[1] A light-reflecting polycarbonate resin sheet having a light-resisting layer which cuts or absorbs UV light in at least one side of a polycarbonate resin foam layer;

[2] A light-reflecting polycarbonate resin sheet described in [1], wherein the polycarbonate foam layer comprising a copolymer of polycarbonate and polysiloxane;

[3] A light-reflecting polycarbonate resin sheet described in [2], wherein the copolymer of polycarbonate and polysiloxane is a copolymer of polycarbonate and polydimethylsiloxane;

[4] A light-reflecting polycarbonate resin sheet described in any of [1] to [3], wherein the polycarbonate resin foam layer has a value of S/D of 15 or more, where S (%) is percent of foamed cell area given by dividing the sum of cross-sectional area of all the foamed cells appearing on the cross-section of the foam layer by the cross-sectional area of the foam, and D (μm) is the number average diameter of the foamed cells;

[5] A light-reflecting polycarbonate resin sheet described in any of [1] to [4], wherein the thickness of the polycarbonate resin foam layer is 0.1 to 2 mm;

[6] A light-reflecting polycarbonate resin sheet described in any of [1] to [5], wherein the light-resisting layer is composed of an acrylic or methacrylic resin copolymerized with one or more kinds of components selected from polymerizable photo-stabilizing components and UV light absorbing components;

[7] A light-reflecting polycarbonate resin sheet described in [6], wherein the polymerizable photo-stabilizing components and UV light absorbing components contain one or more kinds of compounds selected from hindered amine related compounds, benzotriazole related compounds, and benzophenone related compounds;

[8] A light-reflecting polycarbonate resin sheet described in any of [1] to [7], wherein the thickness of the light-resisting layer is 0.4 to 20 μm;

[9] A light-reflecting polycarbonate resin sheet described in any of [1] to [8], wherein the light reflectance as measured by irradiating a light with a wavelength in visible region on the surface of the light-resisting layer is 90% or more;

[10] A light-reflecting polycarbonate resin sheet described in any of [1] to [9], wherein the color difference (ΔE) between before and after UV light irradiation is 10 or less when UV light with an energy of 20 J/cm² from a high-pressure mercury lamp is irradiated on the surface of the light-resisting layer, and reduction in visible light reflectance is 5% or less; and

[11] A light-reflecting laminate, wherein a light-reflecting polycarbonate resin sheet described in any of [1] to [10] is superposed on a metal plate.

### DESCRIPTION OF THE PREFERRED EMBODIMENTS

The light-reflecting polycarbonate resin sheet according to the present invention has a light-resisting layer which cuts or absorbs UV light on a polycarbonate resin foam layer.

In the light-reflecting polycarbonate resin sheet of the invention, there is no limitation for the selection of kind of the polycarbonate resin constituting the polycarbonate resin foam layer and also for the production method of the foam layer. However, the foam layer described below is preferable.

The foam layer is preferably a foam layer prepared by impregnating a supercritical gas into a resin composition containing polycarbonate type resin and degassing the resin composition impregnated with the supercritical gas. The foam layer preferably has a value of S/D of 15 or more, where S (%) is percent of foamed cell area given by dividing the sum of cross-sectional area of all the foamed cells appearing on the cross-section of the foam layer by the cross-sectional area of the foam layer, and D (μm) is the number average diameter of the foamed cells.

When the value of S/D is 15 or more, high reflectance is obtained. In particular, when the value of S/D is 20 or more, a foam layer is obtained with a higher reflectance having a Y value (reflectance) of 95.0% or more, wherein the Y value is measured at a viewing angle of 10 degree using a light source having a wavelength range of visible light.

The shape of each foamed cell is quasi-elliptical in most cases, however each cell has its own distortion. Therefore, by taking a cross-section image of a foam layer, for example, an electron microscope image of the cross-section of a foam layer, into an image processor, transforming the shape of each observed cell into the form of a quasi-ellipse having the same area, and defines the major axis of the quasi-ellipse as the diameter of the observed cell. All of the foamed cells whose images are taken in the image processor are subjected to the same image processing, so that an average of the calculated cell diameters can be used as a number average diameter D (μm) of the foamed cells. Further, the percent of foamed cell area (%) can be obtained by taking the cross-sectional image of the foam layer into an image processor for segmentation, calculating the total area of open portion of each foamed cell, and dividing the obtained total area by the cross-sectional area of the foam layer.

As the polycarbonate resin for the foam layer of the invention, a copolymer of polycarbonate and polysiloxane is used preferably from the point of flame resistance, foaming properties, etc. The foam layer is preferably a foam layer prepared by degassing a resin composition containing the copolymer after a supercritical gas is impregnated into the resin composition.

Here, as an example of the copolymer of polycarbonate and polysiloxane is listed a copolymer having the basic structure represented by the following general formula (I) having a siloxane unit.
R¹ₐ·R²_{b} SiO_{(4-a-b)/2} (I)

In the general formula (I), R¹ is a monovalent organic group having an epoxy group. Specific examples include γ-glycidoxypropyl group, β-(3,4-epoxycyclohexyl)ethyl group, glycidoxymethyl group, epoxy group, and the like. γ-Glycidoxypropyl group is industrially preferred.

R² is a hydrocarbon group having 1 to 12 carbon atoms. Examples of the hydrocarbon group include alkyl group having 1 to 12 carbon atoms, alkenyl group having 2 to 12 carbon atoms, aryl group having 6 to 12 carbon atoms, and arylalkyl group having 7 to 12 carbon atoms. Particularly, phenyl group, vinyl group and methyl group are preferable.

Further, a and b are each a number satisfying the relations of 0<a<2, 0≦b≦2, and 0<a+b<2. Preferably, a is 0<a≦1. Here, when the organic group (R¹) containing an epoxy group is not present at all (a=0), there exist no reacting points to the terminal phenolic hydroxyl groups of the polycarbonate resin, so that a desired copolymer is not obtained. On the other hand, when a is 2 or more, the copolymer becomes an expensive polysiloxane and is economically unfavorable. From the above-described reasons, a is preferably set in the range of 0<a≦1. Further, when b is 2 or more, sufficient heat resistance is not obtained and the molecular weight becomes low, resulting in poor flame retardancy. Hence, b is preferably set in the range of 0≦b<2.

The polysiloxane represented by the general formula (I) having repeating units can be produced by hydrolyzing alone a silane containing epoxy group, such as γ-glycidoxypropyl trimethoxysilane, γ-glycidoxypropylmethyldiethoxysilane, β-(3,4-epoxycyclohexyl)ethyltrimethoxysilane, β-(3,4-epoxycyclohexyl)ethylmethyldiethoxysilane and the like, or by co-hydrolyzing the aforementioned silane containing epoxy group with another alkoxysilane monomer. Co-hydrolysis can be carried out in accordance with a known method as described in Japanese published unexamined application No. H8(1996)-176425, etc.

As the copolymer of polycarbonate and polysiloxane used in the present invention, a copolymer formed from polycarbonate and polydimethylsiloxane blocks is particularly preferable. When a foam having so-called micro-cellular structure is prepared from such copolymer, a foam having high mechanical strength and high light-reflecting properties can be easily obtained. As an example of such polycarbonate-polysiloxane copolymer, for example, a copolymer disclosed in Japanese published unexamined application No. H7(1995)-258532 can be used.

For the copolymer made from polycarbonate and polydimethylsiloxane blocks, it is preferable that the amount of the polydimethylsiloxane blocks is in the range between 0.5% or more by mass and 10% or less by mass and the amount of fraction soluble in n-hexane is 1.0% or less by mass, with respect to 100% by mass of the copolymer, and the viscosity-average molecular weight in the range between 10,000 or more and 50,000 or less.

By regulating the molecular weight of the copolymer within the above range, a copolymer having good heat resistance, mechanical strength and foaming properties can be obtained. Also by regulating the amount of fraction soluble in n-hexane at 1.0% or less by mass, good impact resistance, flame resistance and foaming properties can be obtained. The fraction soluble in n-hexane means a fraction that is extracted from a target copolymer using n-hexane as a solvent.

The foam structure of the foam layer can be either a closed-cell foam having foamed closed-cells or an open-cell foam having no foamed closed-cells. For the open-cell foam, is listed an example of a foam where a resin phase and a foamed cell phase are each formed continuously and they are entangled with each other and develop a periodic structure.

For the closed-cell foam, the number-average cell diameter is preferably 10 μm or less, particularly preferably 5 μm or less. When the number-average cell diameter is 10 μm or less, the merit of micro-cellular structure, i.e., the merit of maintaining an original stiffness before foaming can be sufficiently attained. Also, a foam thus prepared has a sufficient reflectance. Generally, the closed-cell foam has a foaming magnification of 1.1 times or more and 3 times or less, preferably 1.2 times or more and 2.5 times or less.

In the case of the open-cell foam with a periodic structure, in view of the foam structure and reflectance, the length of one period is 5 nm or more and 100 μm or less, preferably 10 nm or more and 50 μm or less. Hence, the foaming magnification of the open-cell foam is not limited as long as the periodic structure is maintained, but it is generally 1.1 times or more and 3 times or less, preferably 1.2 times or more and 2.5 times or less.

The foam layer of the invention can be produced by impregnating a supercritical gas, which is in a supercritical state into a resin composition containing the above-described copolymer of polycarbonate and polysiloxane, then degassing the resin composition. Here, the supercritical state means a state that shows intermediate properties between gas state and liquid state. A gas reaches a supercritical state when its pressure and temperature go beyond a given point (critical point) that is specific for the gas, where the gas can get a stronger penetration for impregnation into resin as compared with liquid state and can be impregnated uniformly.

Any gas can be used for impregnation as long as the gas can penetrate into resin in its supercritical state. For example, gases such as carbon dioxide, nitrogen, air, oxygen, hydrogen or inert gas like helium are cited. Particularly, carbon dioxide and nitrogen are preferable.

A method and apparatus used for producing a closed-cell foam by impregnating a supercritical gas into a resin composition generally comprises a molding step in which the resin composition is molded, and a foaming step in which the supercritical gas is impregnated into the resin composition and then the resin composition is foamed by degassing. There are a batch-wise foaming method in which the molding step and foaming step are carried out separately and a continuous foaming method in which the molding step and foaming step are carried out continuously. For example, a molding method and a production apparatus described in the specification of U.S. Pat. No. 5,158,986, Japanese published unexamined application No. H10(1998)-230528, etc. can be used.

In the injection or extrusion foaming method (continuous foaming method) where a supercritical gas is impregnated into a resin composition in an extruder, blowing the supercritical gas into the resin composition while it is kneaded in the extruder is used commonly. Specifically, in the present invention, the temperature in the gas atmosphere is preferably selected at the temperature near the glass transition temperature (Tg) or higher, more specifically, higher than the temperature that is 20° C. lower than the glass transition temperature (Tg). By selecting the temperature in the above-described manner, resin and gas are easy to mix uniformly with each other. The upper limit of the temperature can be freely selected in the range where the resin material suffers no adverse effect. It is preferable that the temperature range does not exceed the glass transition temperature (Tg) by 50° C. Beyond this temperature, the mechanical strength of the foam might be lowered by enlargement of the periodic structure or the size of the foamed cells of the foam, or by thermal degradation of the resin composition.

The gas pressure when a gas is impregnated into a resin is essential to be higher than the supercritical pressure of the gas to be impregnated, preferably 15 MPa or more, particularly preferably 20 MPa or more.

The amount of the gas to be impregnated is determined in accordance with a desired foaming magnification. In the present invention, the amount is generally 0.1% or more by mass and 20% or less by mass with respect to the mass of the resin, preferably 1% or more by mass and 10% or less by mass.

Further, the impregnation time of gas is not particularly limited, and can be selected appropriately in accordance with impregnation method or thickness of the resin. There is such a correlation that higher impregnation of gas results in a larger periodic structure, while lower impregnation of gas results in a smaller periodic structure.

In the case of batch-wise impregnation, the impregnation time of gas is generally 10 minutes or more and 2 days or less, preferably 30 minutes or more and 3 hours or less. In the injection-extrusion method, it is sufficient to set the impregnation time of gas 20 seconds or more and 10 minutes or less because impregnation can proceed with higher efficiency.

A foam is obtained by degassing the resin composition impregnated with supercritical gas under a reduced pressure. When considering this foaming, it is sufficient to reduce the pressure below the critical pressure of the impregnated gas, however, the pressure is generally reduced to normal pressure for the purpose of handling, etc. and in many cases cooling is performed while the pressure is reduced. Preferably, during degassing, the resin composition impregnated with a supercritical gas is cooled to a temperature in the range of Tg±20° C. This is because, if the resin composition is degassed outside of this temperature range, crude foams might develop or the mechanical strength or stiffness might be lowered by insufficient crystallization of the resin composition despite uniform foaming.

In the above-described injection or extrusion foaming method (continuous foaming method) where a supercritical gas is impregnated in a resin composition in an extruder, it is particularly preferable that the resin composition impregnated with the supercritical gas is filled in a die, and then the die is set back to reduce the pressure applied to the resin composition impregnated with the supercritical gas. This is because, by this operation, foaming failure does not develop easily near the gate, so that a uniform foamed structure can be obtained.

Further, even in the batch-wise foaming method where a gas is impregnated by placing a molded article of the resin composition in an autoclave filled with the supercritical gas, the conditions during degassing similar to those used in the above-described injection or extrusion foaming method (continuous foaming method) can be applied. Further, a temperature in the range of Tg±20° C. should be maintained for degassing for a sufficient period of time.

In addition, either in continuous or batch-wise foaming method, in order to obtain a foamed structure having uniform closed foamed cells, it is preferable that the cooling rate of the resin composition is less than 0.5° C./sec and cooling is carried out at the glass transition temperature or lower.

Further, in order to obtain a foamed structure having uniform closed foamed cells, the rate of reducing the pressure applied to the resin composition is preferably less than 20 MPa/sec, more preferably less than 15 MPa/sec, particularly preferably less than 0.5 MPa/sec. Even at a rate of reducing the pressure of 20 MPa/sec or more, if the resin composition is not cooled or cooled at an extremely low rate, spherical closed-cells tend to develop easily.

On the other hand, for producing a foam having a periodic structure in which a resin phase and a foamed-cell phase are each continuously formed resulting in an entangled periodic structure, it is preferable to carry out rapid cooling and rapid pressure reduction of the resin composition impregnated with the supercritical gas almost at the same time, after a supercritical gas is impregnated into a resin composition. By this operation, a foamed-cell phase is formed after the gas is evacuated, thereby the foamed-cell phase and the resin phase develop a continuous phase each other in a manner in which these phases are kept entangled with each other.

The method and apparatus for impregnating the supercritical gas into a resin is similar to the production method and apparatus used for the foam of closed-cell type. The preferable conditions of temperature and pressure under which the supercritical gas is impregnated into the resin composition are also similar to those used in the production of the foam of closed-cell type. Cooling after the gas impregnation is carried out at a rate of 0.5° C./sec or more, preferably 5° C./sec or more, further preferably 1° C./sec. Here, the upper limit of the cooling rate depends on the production method of foams, but it is generally 50° C./sec in the batch-wise foaming method and 1,000° C./sec in the continuous foaming method.

Further, the rate of reducing pressure in a degassing step is preferably 0.5 MPa/sec or more in order to obtain a desired foamed structure, more preferably 15 MPa/sec or more, particularly preferably 20 MPa/sec or more and 50 MPa/sec or less. When the pressure is eventually reduced to 50 MPa or less, the resultant open-cell porous structure is kept in frozen.

Rapid cooling and reducing of the pressure are carried out almost at the same time. In addition, there arises no problem when rapid cooling of the resin impregnated with a gas is carried out at first followed by rapid reducing of the pressure, however, when rapid reducing of the pressure is carried out without cooling, spherical closed-cells tend to develop easily in the resin.

As mentioned above, any process including batch-wise, extrusion, or injection molding can be used for producing a foam layer from the resin composition containing a copolymer of polycarbonate and polysiloxane.

A light-resisting layer constituting the light-reflecting-polycarbonate resin sheet of the present invention has a function of cutting or absorbing UV light. Cutting or absorbing UV light can be attained by incorporating one or more kinds of agents selected from photo-stabilizers and UV light absorbing agents into the light-resisting layer.

The photo-stabilizers and UV light absorbing agents are suitably organic compounds such as hindered amine related compounds, salicylic acid related compounds, benzophenone related compounds, benzotriazole related compounds, benzoxazinone related compounds, cyanoacrylate related compounds, triazine related compounds, benzoate related compounds, oxanilide related compounds or organo-nickel related compounds, or inorganic compounds prepared by sol-gel process and the like.

Specific examples of the hindered amine related compounds include bis(2,2,6,6-tetramethyl-4-piperidyl) sebacate, succinic acid dimethyl-1-(2-hydroxyethyl)-4-hydroxy-2,2,6,6-tetramethylpiperidine polycondensate, tetrakis(2,2,6,6-tetramethyl-4-piperidyl)-1,2,3,4-butanetetracarboxylate, 2,2,6,6-tetramethyl-4-piperidylbenzoate, bis-(1,2,2,6,6-pentamethyl-4-piperidyl)-2-(3,5-di-t-butyl-4-hydroxybenzyl)-2-n-butylmalonate, bis-(N-methyl-2,2,6,6-tetramethyl-4-piperidyl)sebacate, 1,1′-(1,2-ethanediyl)bis(3,3,5,5-tetramethylpiperazinone), and the like.

Specific examples of the salicylic acid related compounds include p-t-butylphenylsalicylate, p-octylphenylsalicylate, and the like.

Specific examples of the benzophenone related compounds include 2-hydroxy-4-n-octoxybenzophenone, 2-hydroxy-4-methoxybenzophenone, 2-hydroxy-4-ethoxybenzophenone, 2,4-dihydroxybenzophenone, 2-hydroxy-4-methoxy-5-sulfobenzophenone, 2,2′,4,4′-tetrahydroxybenzophenone, 2,2′-dihydroxy-4-methoxybenzophenone, 2,2′-dihydroxy-4,4′-dimethoxybenzophenone, bis(2-methoxy-4-hydroxy-5-benzoylphenyl)methane, and the like.

Specific examples of the benzotriazole related compounds include 2-(2′-hydroxy-5′-methylphenyl)benzotriazole, 2-(2′-hydroxy-5′-t-butylphenyl)benzotriazole, 2-(2′-hydroxy-3′,5′-di-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-5′-t-octylphenol) benzotriazole, 2-(2′-hydroxy-3′,5′-di-t-amylphenyl)benzotriazole, 2,2′-methylenebis[4-(1,1,3,3-tetramethylbutyl)-6-(2H-benzotriazol-2-yl)phenol], 2-(2′-hydroxy-5′-methacryloxyphenyl)-2H-benzotriazole, 2-[2′-hydroxy-3′-(3″,4″,5″,6″-tetrahydrophthalimidomethyl)-5′-methylphenyl]benzotriazole, 2-(2′-hydroxy-5-acryloyloxyethylphenyl)-2H-benzotriazole, 2-(2′-hydroxy-5′-methacryloxyethylphenyl)-2H-benzotriazole, 2-(2′-hydroxy-3′-t-butyl-5′-acryloylethylphenyl)-5-chloro-2H-benzotriazole, and the like.

Specific examples of the cyanoacrylate related compounds include 2-ethyl-2-cyano-3,3-diphenylacrylate, 2-ethylhexyl-2-cyano-3,3-diphenylacrylate, 1,3-bis-[2′-cyano-3,3′-diphenylacryloyloxy]-2,2-bis-[(2-cyano-3′,3′-diphenylacryloyl)oxy]methylpropane, and the like.

Specific examples of the triazine related compounds include 2-(4,6-diphenyl-1,3,5-triazin-2-yl)-5-(hexyl)oxyphenol, 2-(4,6-bis-2,4-dimethylphenyl-1,3,5-triazin-2-yl)-5-(hexyl)oxyphenol, and the like.

Specific examples of the benzoate related compounds include 2,4-di-t-butylphenyl-3′,5′-di-t-butyl-4′-hydroxybenzoate, resorcinol monobenzoate, methyl orthobenzoylbenzoate, and the like. Specific examples of the oxyanilide related compounds include 2-ethoxy-2′-ethyloxalic acid bisanilide and the like, and specific examples of the organo-nickel related compounds include nickel bis(octylphenyl)sulfide, [2,2′-thiobis(4-t-octylphenolate)]-n-butylamine nickel, nickel complex-3,5-di-t-butyl-4-hydroxybenzyl-phosphoric acid monoethylate, nickel dibutyldithiocarbamate, and the like.

Specific examples of the benzoxazinone related compounds include 2,2′-(1,4-phenylene) bis[4H-3,1-benzoxazin-4-one] and the like.

Specific examples of the malonic acid ester related compounds include propanedioic acid [(4-methoxyphenyl)methylene]dimethylester and the like.

Of these compounds, the hindered amine related compounds, benzophenone related compounds, and benzotriazole related compounds are preferred.

In the present invention, it is preferable to use other resin components as appropriate by mixing with a photo-stabilizer and/or UV light absorber in order to facilitate formation of the light-resisting layer containing the photo-stabilizer and/or UV light absorber. That is, a mixed solution prepared by dissolving the resin component and the photo-stabilizer and/or UV light absorber in a solvent, a liquid prepared by dissolving the resin component and either of the photo-stabilizer and/or UV light absorber and by dispersing the other component, or a mixed solution prepared by first dissolving or dispersing separately the resin component and the photo-stabilizer and/or UV light absorber each in a solvent and then mixing the resultant solutions or dispersions is used preferably as a coating liquid. As the solvent, one or more kinds of solvents selected from water and an organic solvent may be used as appropriate. It is also preferable that a copolymer of the photo-stabilizer component and/or UV light absorber component and the resin component are used as it is for the coating liquid.

The resin component admixed or copolymerized with the photo-stabilizer and/or UV light absorber is not particularly limited. Examples of the resin component include polyester, polyurethane, acrylic, methacrylic, polyamide, polyethylene, polypropylene, polyvinylchloride, polyvinylidene chloride, polystyrene, polyvinylacetate, fluoro, and other resins. These resins can be used alone or in a combination of two or more kinds. In the present invention, among the above-described resins, acrylic and methacrylic resins are preferred.

In the present invention, it is preferable to use an acrylic or methacrylic resin copolymerized with a photo-stabilizer component and/or UV light absorber for the light-resisting layer. When copolymerization is carried out, it is preferable to copolymerize a polymerizable photo-stabilizer component and/or UV light absorber component and an acrylic or methacrylic monomer component.

As the polymerizable photo-stabilizer component and UV light absorber component, one or more kinds of compounds selected from hindered amine, benzotriazole or benzophenone related compounds are preferably used. Any polymerizable photo-stabilizer component and UV light absorber component can be used, which has in its base skeleton a hindered amine, benzotriazole or benzophenone and a polymerizable unsaturated bond. They are usually acrylic or methacrylic monomer compounds having at their side chains light absorbing or UV light absorbing functional groups derived from these compounds.

Specific examples of the polymerizable hindered amine related compounds include bis(2,2,6,6-tetramethyl-4-piperidyl-5-acryloyloxyethylphenyl)sebacate, succinic acid dimethyl-1-(2-hydroxyethyl)-4-hydroxy-2,2,6,6-tetramethyl-5-acryloyloxyethyl phenylpiperidine polycondensate, bis(2,2,6,6-tetramethyl-4-piperidyl-5-methacryloxyethylphenyl)sebacate, succinic acid dimethyl-1-(2-hydroxyethyl)-4-hydroxy-2,2,6,6-tetramethyl-5-methacryloxyethylphenylpiperi dine polycondensate, bis(2,2,6,6-tetramethyl-4-piperidyl-5-acryloylethylphenyl)sebacate, succinic acid dimethyl-1-(2-hydroxyethyl)-4-hydroxy-2,2,6,6-tetramethyl-5-acryloylethyl phenylpiperidine polycondensate, and the like.

Specific examples of the polymerizable benzotriazole related compounds include 2-(2′-hydroxy-5-acryloyloxyethylphenyl)-2H-benzotriazole, 2-(2′-hydroxy-5′-methacryloxyethylphenyl)-2H-benzotriazole, 2-(2′-hydroxy-3′-t-butyl-5′-acryloylethylphenyl)-5-chloro-2H-benzotriazole, and the like.

Specific examples of the polymerizable benzophenone related compounds include 2-hydroxy-4-methoxy-5-acryloyloxyethylphenylbenzophenone, 2,2′-4,4′-tetrahydroxy-5-acryloyloxyethylphenylbenzophenone, 2,2′-dihydroxy-4-methoxy-5-acryloyloxyethylphenylbenzophenone, 2,2′-dihydroxy-4,4′-dimethoxy-5-acryloyloxyethylphenylbenzophenone, 2-hydroxy-4-methoxy-5-methacryloxyethylphenylbenzophenone, 2,2′-4,4′-tetrahydroxy-5-methacryloxyethylphenylbenzophenone, 2,2′-dihydroxy-4-methoxy-5-acryloylethylphenylbenzophenone, 2,2′-dihydroxy-4,4′-dimethoxy-5-acryloylethylphenylbenzophenone, and the like.

Specific examples of the acrylic, or methacrylic monomer components or oligomer components thereof copolymerized with the above-described polymerizable photo-stabilizer components and/or UV light absorbers include alkylacrylate, alkylmethacrylate (the alkyl group includes methyl, ethyl, n-propyl, isopropyl, n-butyl, isobutyl, t-butyl, 2-ethylhexyl, lauryl, stearyl, cyclohexyl and the like), and monomers having cross-linking functional groups (for example, monomers having carboxyl, methylol, acid anhydride, sulfonic acid, amido, methylolated amido, amino, alkylolated amino, hydroxyl, epoxy and the like). In addition, the above-described polymerizable photo-stabilizer components and/or UV light absorbers may be copolymerized with acrylonitrile, methacrylonitrile, styrene, butylvinylether, maleic acid, itaconic acid or its dialkylester, methylvinylketone, vinyl chloride, vinylidene chloride, vinyl acetate, vinyl pyridine, vinyl pyrrolidone, alkoxysilane having vinyl group, or unsaturated polyester.

The percentage at which these polymerizable photo-stabilizer and/or UV light absorber components and the copolymerizing monomers are copolymerized is not particularly limited, but the percentage of the polymerizable photo-stabilizer and/or UV light absorber components is preferably 10% or more by mass, more preferably 20% or more by mass, still more preferably 35% or more by mass. A polymer prepared by polymerizing the polymerizable photo-stabilizer and/or UV light absorber components without using the monomers described above may also be used. The molecular weight of the polymers is not particularly limited, but it is usually 5,000 or more, and is preferably 10,000 or more in view of toughness of the resultant coating layer, more preferably 20,000 or more. The polymers are used in a state in which they are dissolved or dispersed in an organic solvent, water, or a mixed solution of an organic solvent and water. Besides the above-described copolymers, a commercially available, hybrid type photo-stabilizer polymer can also be used. Further, “UWR” (trade name, manufactured by NIPPON SHOKUBAI CO., LTD.) which contains a copolymer of acrylic monomer, photo-stabilizer and UV light absorber as an active ingredient, “HC-935UE” (trade name, manufactured by IPPOSHA OIL INDUSTRIES CO., LTD.), which contains a copolymer of acrylic monomer and UV light absorber as an active ingredient, and the like can also be used.

In the present invention, so far as light-reflecting and light-resisting properties of the light-resisting layer are not impaired, additives such as inorganic/organic particles, fluorescent brightening agent, or antistatic agent can be added to the light-resisting layer. As the fluorescent brightening agent, commercially available products such as “UVITEX” (trade name, manufactured by CIBA SPECIALTY CHEMICALS CORP.), “OB-1” (trade name, manufactured by EASTMAN CHEMICAL COMPANY CORP.), “TBO” (trade name, manufactured by SUMITOMO SEIKA CHEMICALS CO., LTD.), “KAYCOLL” (trade name, manufactured by NIPPON SODA CO., LTD.), “KAYALIGHT” (trade name, manufactured by NIPPON KAYAKU CO., LTD.), “LEUCOPHOR EGM” (trade name, manufactured by CLARIANT (JAPAN) K.K.), and the like can be used. The amount of the fluorescent brightening agent added to the light-resisting layer is preferably 0.01 to 2% by mass, more preferably 0.03 to 1.5% by mass, still more preferably 0.05 to 1% by mass in view of effectiveness, resistance to yellowing, durability, etc. As the antistatic agent, phosphonium sulfonate and the like can be used.

In the present invention, as the method of forming the light-resisting layer on the foam layer of polycarbonate resin can be used a method in which a solution of a light-resisting agent is coated to a thickness of preferably 0.4 to 20 μm by direct gravure roll coating, mist atomizing, or spraying, and then the resultant coating is dried in a hot-air oven at about 80 to about 120° C.

In other methods, the light-resisting layer can be formed on a transparent PC or PMMA film in advance using the above-described method, and the resultant film is superposed by heating when the foamed sheet is molded. It is preferable that a releasable protective sheet such as a PET film may be superposed on the light-resisting layer of the film so as to prevent the light-resisting layer from directly contacting touch rolls.

The light-reflecting polycarbonate resin sheet of the present invention can be used, as it is, for a light-reflecting panel. The light-reflecting polycarbonate resin sheet can be superposed on a metal plate and is also used for a light-reflecting panel. The shape of the mold article may be selected in accordance with the shape, number, or characteristics of light sources as appropriate. For the light-reflecting panel used in a direct backlight system of liquid crystal displays, the shape proposed in Japanese published unexamined application Nos. 2000-260213, 2000-356959, 2001-297613, and 2002-32029 can be listed. There is particularly no limitation for the laminating process, but an epoxy or acrylic adhesive can be used for bonding or adhering of the light-reflecting polycarbonate resin sheet to the metal plate.

The light-reflecting polycarbonate resin sheet of the present invention is obtained by the above-described method, of which at least one layer has a foam layer of polycarbonate resin, having a flame retardancy of V-2 class or more, which is evaluated generally at a thickness of 0.4 mm in the vertical flame test in accordance with UL94, and thermoformability.

The thickness of the foam layer in the light-reflecting polycarbonate resin sheet of the invention is about 0.1 to 2 mm, preferably 0.2 to 1 mm, more preferably 0.2 to 0.5 mm. When the thickness of the foam layer is 0.1 mm or more, even in a wide-screen light-reflecting panel, there is no constraint of uneven thickness and no in-plane irregularity of light-reflection develops. Further, when the thickness of the foam layer is 2 mm or less, a temperature difference does not develop easily among the surface of the one side of the panel, inside of the panel, and the surface of the opposite side. As a result, a heat molded article having uniform light-reflecting properties is obtained.

The light-reflecting polycarbonate resin sheet of the present invention has preferably a light reflectance measured by irradiating light with a wavelength in the range of visible light on the surface of the light-resisting layer (light reflectance) of 90% or more, more preferably 97% or more, still more preferably 99% or more. Such a high light reflectance can be attained by regulating the number average diameter of the foamed cells.

For this reason, the number average diameter of the foamed cells is set preferably at 10 m or less, more preferably 5 μm or less, still more preferably 2 μm or less, particularly preferably 1 μm or less. The foaming magnification of a closed-cell foam is generally 1.1 times or more and 3 times or less, preferably 1.2 times or more and 2.5 times or less.

The light-reflecting polycarbonate resin sheet of the present invention has excellent light-resisting properties, generally having a color difference (ΔE) between before and after UV light irradiation of 10 or less when UV light with an energy of 20 J/cm² from a high pressure mercury lamp is irradiated on the surface of the light-resisting layer, and reduction in visible light reflectance of 5% or less.

The light-reflecting polycarbonate resin sheet of the present invention has a light transmittance of generally less than 6%, preferably less than 3%, more preferably less than 1%. Such light cutting properties can be attained by regulating the foaming magnification of the foam layer and the thickness of the foam layer, and good surface conditions.

For a given use where light reflection is required, sufficient brightness can be obtained at a light reflectance of 90% or more and a light transmittance of less than 6%.

As described above, the light-reflecting polycarbonate resin sheet of the present invention has V-2 class flame retardancy at a thickness equivalent to 0.4 mm in the vertical flame test in accordance with UL94, so that it can enhance flame retardancy as a light box.

Further, the light-reflecting polycarbonate resin sheet of the present invention has thermoformability, so that shape design in accordance with the type or number of light sources can be made more easily and that a light box having an even and high brightness can be obtained.

Next, the present invention will be further described in detail with reference to the following examples, but it should be construed that the invention is in no way limited to those examples.

In addition, for each example or comparative example, the evaluation of the light-reflecting polycarbonate resin sheet was carried out by irradiating light with an energy of 20 J/cm² from a high pressure mercury lamp on the light-reflecting foam sheet, and measuring reflectance (Y-value) and color difference (ΔE) before and after visible light irradiation with a spectrophotometer (MACBETH CORP., Model LCM2020 PLUS).

(1) Light-Resisting Properties

Light-resisting properties were evaluated by measuring color difference (ΔE), using an un-irradiated sample as a reference standard, at a viewing angle of 10 degree with an F light source.

(2) Light Reflectance

Light reflectance (SCI), in the range of 400 to 700 nm, including specular reflection was obtained by measuring Y-value at a viewing angle of 10 degree with a D65 light source (wavelength range of visible light). Here, SCI is a light reflection obtained by measuring light reflection including surface gross (specular reflection) of a test sample.

### PRODUCTION EXAMPLE 1

### Production of PC Oligomer

To 400 L of an aqueous sodium hydroxide solution of 5% by mass 60 kg of bisphenol A was dissolved to obtain an aqueous sodium hydroxide solution of bisphenol A. Next, the aqueous sodium hydroxide solution of bisphenol A kept at room temperature at a flow rate of 138 L/hr, and methylene chloride at a flow rate of 69 L/hr were introduced into a tubular reactor having an inner diameter of 10 mm and a length of 10 m through an orifice plate, further phosgene was blown in parallel flow into the reactor at a flow rate of 10.7 kg/hr. They were reacted continuously for 3 hours. The tubular reactor used had a double-pipe structure where cooling water was passed through the jacket to keep the discharge temperature of the reaction solution at 25° C. The pH of the discharge solution was adjusted at 10 to 11.

The reaction solution obtained was left still to separate and remove the aqueous phase, and the resulting methylene chloride phase (220 L) was collected to obtain PC oligomer (317 g/L of concentration). The PC oligomer thus obtained had a polymerization degree of 2 to 4 and a chloroformate concentration of 0.7 normal.

### PRODUCTION EXAMPLE 2

### Production of Reactive PDMS

A solution obtained by mixing 1483 g of octamethylcyclotetrasiloxane, 96 g of 1,1,3,3-tetramethyldisiloxane, and 35 g of 86% by mass sulfuric acid was stirred for 17 hours at room temperature. After separating the oil phase, 25 g of sodium hydrogencarbonate was added to it and the resultant mixture was stirred for 1 hour. After the reaction mixture was filtered, the filtrate was distilled under reduced pressure at 150° C. and 3 torr (400 Pa), and ow boiling point components were removed to obtain an oil product.

To a mixture of 60 g of 2-allylphenol and 0.0014 g of platinum as a platinum chloride-alcoholate complex was added 294 g of the above-obtained oil product at 90° C. The mixture was kept at 90-115° C. and stirred for 3 hours. The resultant product was extracted with methylene chloride, washed with 80% by mass of aqueous methanol solution three times to remove excess 2-allylphenol. The product was dried with anhydrous sodium sulfate and remaining solvent was distilled out under vacuum up to 115° C. The resultant reactive PDMS (polydimethylsiloxane) having terminal phenol groups was subjected to NMR measurement, and the repeating number of dimethylsilanoxy unit was found to be 30.

### PRODUCTION EXAMPLE 3

### Production of PC-PDMS Copolymer

One hundred and thirty eight g of the reactive PDMS obtained in Production Example 2 was dissolved in 2 L of methylene chloride, and here 10 L of the PC oligomer obtained in Production Example 1 was added. To the resultant mixture were added a solution prepared by dissolving 26 g of sodium hydroxide in 1 L of water and 5.7 mL of triethylamine. The resultant reaction mixture was stirred at 500 rpm and reacted at room temperature for 1 hour.

After the reaction, to the reaction mixture were added a solution prepared by dissolving 600 g of bisphenol A in 5 L of 5.2% by mass aqueous sodium hydroxide solution, 8 L of methylene chloride and 96 g of p-tert-butylphenol, and then the resultant mixture was reacted at room temperature while stirring at 500 rpm for 2 hours.

After the reaction, 5 L of methylene chloride were added to the reaction mixture. Further the reaction mixture was subsequently washed with 5 L of water, 5 L of a 0.03 mol/L aqueous sodium hydroxide solution, 5 L of 0.2 mol/L hydrochloric acid, and 5 L of water twice. Finally methylene chloride was removed to obtain a flaky product of PC-PDMS copolymer. The resultant PC-PDMS copolymer was dried at 120° C. for 24 hours under vacuum. The viscosity average molecular weight (Mv) was 17,000 and the PDMS content was 3.0% by mass.

In the above Production Example 3, the viscosity average molecular weight (Mv) and PDMS content were obtained by the following methods:

(1) Viscosity Average Molecular Weight (Mv)

Using an Ubbelohde viscometer, the viscosity of a methylene chloride solution was measured at 20° C. Limiting viscosity [η] was obtained from the viscosity, and Mv was calculated using the following equation.
[η]=1.23×10⁻⁵ Mv^{0.83}

(2) PDMS Content

PDMS content was obtained on the basis of the peak intensity ratio, which was evaluated using the peak of the methyl group of isopropyl of bisphenol A appearing at 1.7 ppm and the peak of the methyl group of dimethylsiloxane appearing at 0.2 ppm in ¹H-NMR measurements.

### PRODUCTION EXAMPLE 4

### Production of PC-PDMS Copolymer Film

[Production of Pre-Foamed Film]

The PC-PDMS copolymer obtained in Production Example 3 was kneaded into pellets, with a biaxial kneading extruder having 35 mm diameter at a kneading temperature of 280° C. and a screw rotation speed of 300 rpm. The resultant pellets were pressed into a 150 mm square×250 μm PC-PDMS copolymer film using a press-molding machine at a press temperature of 280° C. and a gauge pressure of 10 MPa.

[Production of Foamed Film]

The above-described PC-PDMS copolymer film was placed in an autoclave (inner diameter of 180 mm×150 mm), which was a supercritical foaming apparatus (apparatus in which an autoclave equipped with a degassing valve was connected with a carbon dioxide gas cylinder through a liquid-feeding pump), and carbon dioxide gas in a supercritical state, a supercritical gas, obtained by increasing the pressure at room temperature was introduced into the autoclave. After the pressure was increased up to 15 MPa, while keeping the room temperature, the autoclave was put in an oil bath at 140° C. for 1 hour; then, the degassing valve was released so as to reduce the pressure to normal pressure in about 7 seconds, and at the same time the autoclave was cooled by immersing it in a water bath at 25° C. to obtain a 150 mm square×300 μm foamed film.

The foamed film obtained had (1) a uniformity in the distribution of foamed cells, (2) a number average diameter (D) of the foamed cells of 0.8 μm, and (3) a S/D value of 57.1 (S/D=percent of foamed cell area/number average diameter of foamed cells).

The methods used for evaluating the above-described foamed film are as follows:

(1) Uniformity of Foamed Cells:

Uniformity of foamed cells was evaluated by visual observation of the SEM picture of the foamed film.

(2) Number Average Diameter of Foamed Cells (D):

The cross-section image of the foamed film was subjected to image processing using N.I.H. image ver. 1.57 (trade name). The actual cell shape was transformed into an ellipse having the same area with the actual cell, and the major axis of the ellipse was used as the diameter of the actual cell.

(3) S/D (Percent of Foamed Cell Area/Number Average Diameter of Foamed Cells):

The percent of foamed cell area S (%) was obtained according to the following procedure:

A tracing paper was overlaid on an SEM picture, foamed cells seen through the tracing paper in the SEM picture were traced, the traced images were processed with an image processor for segmentation so as to obtain the total area of open portion of each foamed cell, the cross-sectional area of the foamed film was obtained at the same scale as the SEM picture, i.e., the cross-sectional area of the foamed film was obtained by multiplication of the vertical and transverse dimensions measured for the image of the SEM picture, and the value given by dividing the obtained total area of all of the foamed cells appearing on the cross section of the foamed film by the cross-sectional area of the foamed film was taken as the percent of foamed cell area S. In this way, S/D was obtained, which was the ratio of S to the number average diameter of foamed cells D.

### EXAMPLE 1

A solution prepared by diluting the photo-stabilizer “HC-935UE” (trade name, manufactured by IPPOSHA OIL INDUSTRIES CO., LTD.) with ethyl cellosolve in a solid content of 30% by mass was coated using a gravure roll on the light-reflecting face of a 300 μm thick foamed film obtained in Production Example 4 so as to form a 5 μm thick light-resisting layer. The coating was dried in a hot-air oven at 120° C. for 5 minutes. The light-reflecting polycarbonate resin sheet had good thermoformability. The resultant evaluation results for the heat-molded article (light-reflecting polycarbonate resin sheet) are given in Table 1, which includes light-resisting properties (ΔE) and light reflectance (Y-value) before and after light irradiation.

### EXAMPLE 2

In the same manner as described in Example 1, except that the photo-stabilizer “UWR UV-G301” (trade name, manufactured by NIPPON SHOKUBAI CO., LTD.) was used for the light-resisting layer, a light-reflecting foamed sheet was obtained. The light-reflecting foamed sheet had good thermoformability. The evaluation results for the resultant heat-molded article (light-reflecting polycarbonate resin sheet) are given in Table 1.

### EXAMPLE 3

In the same manner as described in Example 1, except that the thickness of the light-resisting layer was 10 μm, a light-reflecting foamed sheet was obtained. The light-reflecting foamed sheet had good thermoformability. The evaluation results for the resultant heat-molded article (light-reflecting polycarbonate resin sheet) are given in Table 1.

### EXAMPLE 4

On one side of a thin aluminum plate (0.2 mm thick; JIS H4000 A3004P) having the same size with the light-reflecting foamed sheet obtained in Example 1 was applied a solution prepared by dissolving a bisphenol-type epoxy resin (having a molecular weight of 380 and an epoxy equivalence of 18 to 200) in trichloroethylene using the roll coating method so as to yield a coating thickness of 1 μm. Subsequently the epoxy-coated side of the thin aluminum plate was heat-treated at 350° C. to obtain a heat-modified coating film. To the heat-modified coating film of the thin aluminum plate was laminated the foamed sheet with the light-resisting layer prepared in Example 1 to obtain a laminate, by superposing at 125° C. so as to expose the light-resisting layer at the surface side. The evaluation results for the resultant laminate are given in Table 1.

### COMPARATIVE EXAMPLE 1

The properties of the 300 μm thick foamed film (without forming a light-resisting layer) obtained in Production Example 4 were evaluated. The foamed film had good thermoformability. The evaluation results are given in Table 1

TABLE 1

| | | | | | Compar- |
|---|---|---|---|---|---|
| | | Exam- | | | ative |
| | Example 1 | ple 2 | Example 3 | Example 4 | Example 1 |
| (Light- | | | | | |
| reflecting | | | | | |
| resin sheet) | | | | | |
| Foam layer | 300 | 300 | 300 | 300 | 300 |
| thickness (μm) | | | | | |
| Light-resisting | 5 | 5 | 10 | 5 | — |
| layer thickness | | | | | |
| (μm) | | | | | |
| Photo-stabilizer | HC935UE | UV- | HC935UE | HC935UE | |
| | | G301 | | | |
| Metal plate | — | — | — | 0.2 | — |
| thickness (mm) | | | | | |
| (Evaluation) | | | | | |
| Light resistance | 3.5 | 3.8 | 3.8 | 3.5 | 10 |
| (ΔE) | | | | | |
| Light | | | | | |
| reflectance | | | | | |
| (Y-value, %) | | | | | |
| Before | 101.5 | 101.5 | 101.4 | 101.4 | 101.6 |
| irradiation | | | | | |
| After | 100.1 | 100.3 | 99.9 | 100.2 | 93.2 |
| irradiation | | | | | |

### INDUSTRIAL APPLICABILITY

The light-reflecting polycarbonate resin sheet according to the present invention has high light resistance while maintaining excellent reflective characteristics. For example, when a light with an energy of 20 J/cm² from a UV light source having a wavelength corresponding to a cold cathode ray tube is irradiated, the color difference (ΔE) between before and after irradiation is 10 or less and reduction in the visible light reflectance was 5% or less.

In addition, the light-reflecting polycarbonate resin sheet according to the present invention is capable of thermoforming that is difficult to be obtained with hard coating used for the conventional PC foamed sheets (films).

Further, the light-reflecting polycarbonate resin sheet according to the present invention has thermoformability, so that shape design in accordance with the type or number of light sources can be made more easily and a light box having a uniform and high brightness can be obtained.

1: A light-reflecting polycarbonate resin sheet comprising a light-resisting layer incorporated into a foam layer of polycarbonate resin, wherein the light-reflecting layer cuts or absorbs UV light.

2: The light-reflecting polycarbonate resin sheet according to claim 1, wherein the polycarbonate foam layer comprises a copolymer of polycarbonate and polysiloxane.

3: The light-reflecting polycarbonate resin sheet according to claim 2, wherein the copolymer of polycarbonate and polysiloxane is a copolymer of polycarbonate and polydimethylsiloxane.

4: The light-reflecting polycarbonate resin sheet according to claim 1, wherein the polycarbonate resin foam layer has a value of S/D of 15 or more, wherein S (%) is percent of foamed cell area given by dividing the sum of cross-sectional area of all the foamed cells appearing on the cross-section of the foam layer by the cross-sectional area of the foam, and D (μm) is the number average diameter of the foamed cells.

5: The light-reflecting polycarbonate resin sheet according to claim 1, wherein the thickness of the polycarbonate resin foam layer is 0.1 to 2 mm.

6: The light-reflecting polycarbonate resin sheet according to claim 1, wherein the light-resisting layer comprises an acrylic or methacrylic resin copolymerized with one or more components selected from the group consisting of polymerizable photo-stabilizing components, UV light absorbing components, and mixtures thereof.

7: The light-reflecting polycarbonate resin sheet according to claim 6, wherein the polymerizable photo-stabilizing components and UV light absorbing components comprise at least one compound selected from the group consisting of hindered amine compounds, benzotriazole compounds, benzophenone compounds, and mixtures thereof.

8: The light-reflecting polycarbonate resin sheet according to claim 1, wherein the thickness of the light-resisting layer is 0.4 to 20 μm.

9: The light-reflecting polycarbonate resin sheet according to claim 1, wherein the light reflectance, as measured by irradiating a light with a wavelength in visible region on the surface of the light-resisting layer, is 90% or more.

10: The light-reflecting polycarbonate resin sheet according to claim 1, wherein the color difference (ΔE), between before and after UV light irradiation, is 10 or less when UV light with an energy of 20 J/cm², from a high pressure mercury lamp, is irradiated on the surface of the light-resisting layer, and reduction in visible light reflectance is 5% or less.

11: A light-reflecting laminate comprising the reflecting polycarbonate resin sheet according to claim 1 and a metal plate.

12: The light-reflecting polycarbonate resin sheet according to claim 2, wherein the thickness of the polycarbonate resin foam layer is 0.1 to 2 mm.

13: The light-reflecting polycarbonate resin sheet according to claim 3, wherein the thickness of the polycarbonate resin foam layer is 0.1 to 2 mm.

14: The light-reflecting polycarbonate resin sheet according to claim 4, wherein the thickness of the polycarbonate resin foam layer is 0.1 to 2 mm.

15: The light-reflecting polycarbonate resin sheet according to claim 2, wherein the thickness of the light-resisting layer is 0.4 to 20 μm.

16: The light-reflecting polycarbonate resin sheet according to claim 3, wherein the thickness of the light-resisting layer is 0.4 to 20 μm.

17: The light-reflecting polycarbonate resin sheet according to claim 4, wherein the thickness of the light-resisting layer is 0.4 to 20 μm.

18: The light-reflecting polycarbonate resin sheet according to claim 6, wherein the thickness of the light-resisting layer is 0.4 to 20 μm.

19: The light-reflecting polycarbonate resin sheet according to claim 7, wherein the thickness of the light-resisting layer is 0.4 to 20 μm.

20: The light-reflecting polycarbonate resin sheet according to claim 2, wherein the light reflectance, as measured by irradiating a light with a wavelength in visible region on the surface of the light-resisting layer, is 90% or more.
